(19) United States
(12) Patent Application Publication
(10) Pub. No.: US 2026/0237314 A1
(43) Pub. Date: Aug. 13, 2026

(54) SYSTEM AND METHOD FOR ASSESSING DENTAL PREPARATION INCLUDING SCAN ADAPTER THEREFOR

(71) Applicant: Tactile Robotics Ltd., Winnipeg (CA)

(72) Inventors: Ali Maddahi, Winnipeg (CA); Maryam Kalvandi, Winnipeg (CA); Vishwa Wengappuliarachchi, Winnipeg (CA); Yaser Maddahi, Winnipeg (CA)

(21) Appl. No.: 19/284,083

(22) Filed: Jul. 29, 2025

Related U.S. Application Data
(60) Provisional application No. 63/677,207, filed on Jul. 30, 2024.

(51) Int. Cl. G09B 5/02; G06T 7/00; G06T 7/13; G06V 10/74; G06V 20/64; G09B 23/28

(52) U.S. Cl. CPC G09B 5/02; G06T 7/0014; G06T 7/13; G06V 10/761; G06V 20/64; G09B 23/283; G06T 2207/20081; G06T 2207/30036; G06V 2201/03

(57) ABSTRACT

An automated measurement system provides precise measurements of a dental preparation to assess the dental skills of students for grading using artificial intelligence and data analysis techniques. The system includes a dental typodont adapter for calibrating the scanning process and capturing data from intraoral or single-tooth scanners. The system generates three-dimensional graphical presentations and various two-dimensional views of the tooth, including detected reduction borders for reduction assessment, allowing for precise and accurate measurements of tooth geometry in relation to a base frame. This enables trainees to assess their skills, prepare for procedures, and compare their work with that of their trainers or with an intact (healthy) tooth.

This application claims the benefit under 35 U.S.C. 119(e) of U.S. provisional application Ser. No. 63/677,207, filed Jul. 30, 2024.

### FIELD OF THE INVENTION

The present invention relates to a system a method of use for quantitively assessing a preparation of a dental training model by scanning the preparation and processing the resulting objection file by comparison to reference data, in some instances using an adapter arranged to be mounted on the dental training model to identify a spatial relation between the object file of the preparation and the reference data.

### BACKGROUND

Currently, teaching dental students how to perform dental procedures in operative dentistry primarily follows a traditional model. The trainer demonstrates a dental task on a tooth, after which apprentices learn the technical aspects and begin practicing. During practice, the apprentices perform dental preparations on a tooth in a pre-clinic setting. Once a dental apprentice completes the preparation, their work is submitted to the trainer for grading and feedback. The trainer typically uses tools like calipers to measure the dimensions (length, depth, and angle) of the dental preparation. Before this submission, trial and error play a significant role in the apprentices' learning process, helping them develop the psychomotor skills necessary to feel confident in performing the task.

In dentistry training programs, the use of classroom and hands-on training by experts has been the standard mechanism of instruction. This is also called the traditional novice-expert apprenticeship model, as described in K. Kunkler, “The role of medical simulation: an overview”, Int. J. of Medical Robotics and Computer Assisted Surgery, vol. 2, pp. 203-210, 2006. In this traditional model, dental and dental hygiene students (hereafter called apprentices) acquire technical dental skills through years of hands-on training in dental laboratories, pre-clinic laboratories, and clinics, and receive supervision and feedback from their instructors relating to dental performance skills. Specifically, instructors conduct a procedure, and the apprentices observe, then assist, and finally perform that procedure under instructor supervision. This is how apprentices acquire years of hands-on training and practice in mastering the required skills. Using the traditional novice-expert apprenticeship model in the field of dentistry, the actions performed while teaching versus practicing differ, as the task is normally done by the instructor, and the apprentices then practice that task. Allowing the instructor to assess/score dental operations in a consistent and accurate manner would help apprentices have a better understanding of their dental skills and implement the knowledge learned in the classroom more quickly and efficiently. Currently, dentistry schools are lacking this ability.

Durbin D, Durbin D, Dalmia A, Childers E, inventors: IOS Technologies Inc, assignee. 3D dental scanner, U.S. Pat. No. 7,494,338. 2009 Feb. 24 discloses systems and methods for optically imaging a dental structure within an oral cavity by moving one or more image apertures on the arm coupled to a fixed coordinate reference frame external to the oral cavity; determining the position of the one or more image apertures using the fixed external coordinate reference frame; capturing one or more images of the dental structure through one or more of the image apertures, and generating a 3D model of the dental structure based on the captured images.

Jumpertz R, inventor: Dentsply Sirona Inc, assignee. Extraoral dental scanner, U.S. Pat. No. 10,463,458. 2019 Nov. 5 discloses an extraoral dental scanner for 3D capture of the surface of a dental shaped part with a 3D measuring camera having an optical axis, wherein the means for the machine-controlled relative positioning of the 3D measuring camera and the dental shaped part are embodied in such a way that the means for taking up and positioning the dental shaped part can be moved into a parking position outside a region that can be captured optically by the 3D measuring camera, with a work plate for manually positioning the dental shaped part in the measurement volume of the 3D measuring camera, wherein the work plate is aligned perpendicularly to the optical axis and wherein the work plate, as viewed from the 3D measuring camera, is arranged behind the means for taking up and positioning the dental shaped part, makes it possible to record uninterrupted 3D image data with very short recording times both by automatic and by manual positioning of dental shaped parts of different sizes and embodiment variants.

Andersson M, Faldt J, Karlsson P O, inventors: Nobel Biocare Services AG, assignee. Method and apparatus for obtaining data for a dental component and a physical dental model. U.S. Pat. No. 9,937,023. 2018 Apr. 10 discloses methods for obtaining data and for manufacturing a dental component and a physical dental model of at least a part of a dental structure are provided which can improve processing times and provide sufficient manufacturing accuracy. An embodiment of the method can comprise obtaining a first data record for manufacturing the dental component and a second data record for manufacturing the physical dental model. The first data record can comprise data based on a portion of a digital dental model. The second data record can comprise data based on at least the portion of the digital dental model. In this regard, the data upon which the first and second data records are based can be obtained using first and second scanning resolutions in order to improve processing times and provide sufficient accuracy.

Levin A, inventor: Align Technology Inc, assignee. Estimating a surface texture of a tooth. U.S. Pat. No. 9,192,305. 2015 Nov. 24 discloses embodiments for estimating a surface texture of a tooth are described herein. One method embodiment includes collecting a sequence of images utilizing multiple light conditions using an intra-oral imaging device and estimating the surface texture of the tooth based on the sequence of images.

Steingart B, Rawley C, Cook C, Itkowitz B, Kittler R, James B, Cooper B, inventors. Systems for haptic design of dental restorations. United States patent application U.S. Ser. No. 11/998,457. 2008 Oct. 23 discloses an invention that provides systems for integrated haptic design and fabrication of dental restorations that provide significant advantages over traditional practice and existing computer-based systems. The systems feature technical advances that result in significantly more streamlined, versatile, and efficient design and fabrication of dental restorations. Among these technical advances are the introduction of voxel-based models; the use of a combination of geometric representations such as voxels and NURBS representations; the automatic identification of an initial preparation (prep) line and an initial path of insertion; the ability of a user to intuitively, haptically adjust the initial prep line and/or the initial path of insertion; the automatic identification of occlusions and draft angle conflicts (e.g., undercuts); the haptic simulation and/or marking of occlusions and draft angle conflicts; and coordination between design output and rapid prototyping/milling and/or investment casting.

Trissel R G, inventor, IOS TECHNOLOGIES, assignee. Polarizing multiplexer and methods for intra-oral scanning. U.S. Pat. No. 7,312,924. 2007 Dec. 25 discloses a polarizing multiplexer includes a first arm with a first beam splitter to receive a first unpolarized light from an object and a first retarder coupled to the first beam splitter to generate a first right-hand circularly polarized (RHCP) beam. A normal incident beam splitter is used to receive the first RHCP beam. The multiplexer also includes a second arm with a second beam splitter to receive a second unpolarized light from an object; and a second retarder coupled to the second beam splitter to generate a left-hand circularly polarized (LHCP) beam, wherein the LHCP beam is reflected off the normal incident beam splitter and converted to a second RHCP beam. Light from both arms pass through the second retarder and are converted to p-polarized light before transmitting through the second beam splitter to an image sensor.

Sadafumi O O, Hamano S, Sugata F, inventors: Panasonic Corp, assignee. Intra-oral measurement device and intra-oral measurement system. United States patent application publication no. US 2010/0253773 discloses an intra-oral measurement device according to the present invention is provided with a light projecting unit for irradiating lights in at least two different wavelengths along an identical light axis toward an object to be measured that includes at least a tooth in an oral cavity, and an image pickup unit for receiving lights reflected on the object to be measured and picking up an image, so that an intra-oral shape can be accurately measured without spraying the metal powder within the oral cavity.

Childers E M, inventor: IOS TECHNOLOGIES, assignee. Method and system for obtaining high resolution 3-D images of moving objects by use of sensor fusion. U.S. Pat. No. 7,672,504. 2010 Mar. 2 discloses a system to scan 3D images applies sensor fusion of a passive triangulation sensor in combination with an active triangulation sensor to obtain high resolution 3D surface models from objects undergoing arbitrary motion during the data acquisition time.

Sadafumi O O, Hamano S, Sugata F, inventors: Panasonic Corp, assignee. Intra-oral measurement device and intra-oral measurement system. U.S. Pat. No. 8,279,450. 2012 Oct. 2 discloses an invention that aims to provide an intra-oral measurement device and an intra-oral measurement system capable of measuring an inside of an oral cavity at high accuracy without increasing a size of the device, and includes a light projecting unit for irradiating a measuring object including at least a tooth within an oral cavity with light, a lens system unit for collecting light reflected by the measuring object, a focal position varying mechanism for changing a focal position of the light collected by the lens system unit, and an imaging unit for imaging light passed through the lens system unit.

Ouadling H S, Ouadling M S, Blair A, inventors: D4D Technologies LP, assignee, Laser digitizer system for dental applications. U.S. Pat. No. 7,573,583. 2009 Aug. 11 discloses an intra-oral laser digitizer system provides a 3D visual image of a real-world object such as a dental item through a laser digitization. The laser digitizer captures an image of the object by scanning multiple portions of the object in an exposure period. The intra-oral digitizer may be inserted into an oral cavity (in vivo) to capture an image of a dental item such as a tooth, multiple teeth or dentition. The captured image is processed to generate the 3D visual image.

Atiya Y, Verker T, inventors; Align Technology Inc, assignee. Compact confocal dental scanning apparatus. U.S. Pat. No. 10,456,043. 2019 Oct. 29 discloses apparatuses and methods for confocal 3D scanning. The apparatus can comprise a spatial pattern disposed on a transparent base and a light source configured to provide illumination to the spatial pattern and an optical system comprising projection/imaging optics having one or more lenses and an optical axis. The projecting/imaging optics may be scanned to provide depth scanning by moving along the optical axis.

Hultgren B W, inventor: Iris Development Corp, assignee. Dental scanning method and apparatus. U.S. Pat. No. 6,217,334. 2001 Apr. 17 discloses a dental and soft tissue scanning method and system is disclosed which uses fast laser line scanning techniques of negative image impressions, whereby an array of electronic data is generated. In operation the array of negative image scan data is generated by a scanner and provided to a processor. The negative image scan data may be saved in a memory device as a permanent record of the baseline condition of the patient's teeth, or temporarily prior to one of several other options. The processor may convert the data to a positive image for display on the video display unit for teaching or educational purposes with the patient. Alternatively, the positive information data may be transmitted to a remote PC for storage, study by a consulting dentist (or physician), or fabrication of a study cast by fabrication device. These and other options may be selected by the user of computer via the input device. The programming operation of the processor provides for scanning each of the upper and lower impressions and the bite registration impression. These scans provide the information necessary to create an electronic equivalent of a physical study cast.

Elbaz G, Lampert E, Atiya Y, Kopelman A, Saphier O, Moshe M, Ayal S, inventors: Align Technology Inc, assignee. Intraoral scanner with dental diagnostics capabilities. U.S. Pat. No. 10,606,911. 2020 Mar. 31 discloses methods and apparatuses for generating a model of a subject's teeth. Described herein are intraoral scanning methods and apparatuses for generating a 3D model of a subject's intraoral region (e.g., teeth) including both surface features and internal features. These methods and apparatuses may be used for identifying and evaluating lesions, caries and cracks in the teeth. Any of these methods and apparatuses may use minimum scattering coefficients and/or segmentation to form a volumetric model of the teeth.

Doherty M, Daniel Y, Zeitlin E, Sanilevici K, Sirat G Y, Agronik G, inventors: Optimet Optical Metrology Ltd, assignee. Double-sided measurement of dental objects using an optical scanner. U.S. Pat. No. 7,728,989. 2010 Jun. 1 discloses methods for digitizing complex surfaces of dental objects such as impressions of dental surfaces and shapes. While an impression mold is being scanned by translation along a known trajectory, typically in a plane, the line of sight of a distance probe is directed toward successive positions on the surface of the impression mold, such as by a periodic series of reflecting surfaces characterized by normal vectors at distinct non-orthogonal angles with respect to their axis of symmetry. One or more reference objects are scanned using the same translation and mirror positioning systems. Gathered coordinate data are processed to apply angular corrections and combined to form a single distortion-corrected image of the impression mold. An apparatus and methods are provided for measuring both sides of a dental object separately, and then registering the two sides relative to each other in a digital representation of the object.

Rohalv J, Nazzal R N, Tekeian E K, Kriveshko I A, Paley E B, inventors: Midmark Corp, assignee. Video-assisted margin marking for dental models. U.S. Pat. No. 10,667,887. 2020 Jun. 2 discloses tools are described for preparing digital dental models for use in dental restoration production processes, along with associated systems and methods. Dental modeling is improved by supplementing views of 3D models with still images of the modeled subject matter. Video data acquired during a scan of the model provides a source of still images that can be displayed alongside a rendered 3D model, and the two views (model and still image) may be synchronized to provide a common perspective of the model's subject matter. This approach provides useful visual information for disambiguating surface features of the model during processing steps such as marking a margin of a prepared tooth surface for a restoration. Interactive modeling tools may be similarly enhanced. For example, tools for margin marking may synchronize display of margin lines between the still image and the model so that a user can interact with either or both of the visual representations, with changes to a margin reflected in both displays.

Lee Y, inventor; DOF Inc, assignee. Desktop three-dimensional scanner for dental use provided with two-axis motion unit in which camera and projector are coupled to unit for changing horizontal axis of rotation of stage. U.S. Pat. No. 9,737,381. 2017 Aug. 22 discloses a desktop 3D scanner for dental use of the related art, a two-axis rotation motion unit, on which a target object can be placed and rotated in order to image the entire shape of the target object, is coupled to the scanner, and thus, when a subject is placed on the imaging stage and is rotated along the horizontal axis of rotation of the stage, the subject is dropped from the stage by gravity after being inclined, and accordingly, additional fixing means or a receiving jig should be placed on the stage together with the subject to prevent same. In such a case, inconvenience is caused because the target objects to be scanned have various shapes and the fixing means or receiving jigs should fit the shapes thereof. According to one embodiment of the desktop 3D scanner for dental user of the present invention, a camera and a projector are provided on the unit for changing the horizontal axis of rotation of the imaging stage, and thus a target object does not have to be inclined during the scanning process and dental prostheses of various shapes can be three-dimensionally scanned even without additional fixing means or a receiving jig.

Marshall M C, inventor, GeoDigm Corp, assignee. System and method for generating an electronic model for a dental impression having a common coordinate system. U.S. Pat. No. 7,702,492. 2010 Apr. 20 discloses a system for generating an electronic model having a common coordinate system that includes a scanning device; a first plate module; and a second plate module. Each of the plate modules is configured to separately couple to the scanning device. The plate modules also can be moveably coupled together using an articulation device. Each of the plate modules includes alignment structures (e.g., spheres) to facilitate determining a position and orientation of the plate modules within a coordinate system of the scanning device.

Getto P, Sachdeva R, Sporbert P, Kaufmann M, inventors: Orametrix Inc, assignee. Generating three dimensional digital dentition models from surface and volume scan data. U.S. Pat. No. 9,412,166. 2016 Aug. 9 discloses a method and apparatus are disclosed enabling an orthodontist or a user to create an integrated 3D digital model of the dentition, and surrounding anatomy of an orthodontic patient from a 3D digital model obtained using a scanner with a 3D digital model obtained using a Cone Beam Computed Tomography (CBCT) or Magnetic Resonance Tomography (MRT) imaging devices. The digital data obtained from scanning as well as from CBCT imaging are downloaded into a computer workstation, and registered together in order to create a comprehensive 3-D model of the patient's teeth with roots, bones and soft tissues. The invention provides a substantial improvement over the traditional 2S imaging modalities such as x-rays, photographs, cephalometric tracing for diagnosis and treatment planning.

Seidl F, Schaller H, inventors: Straumann Holding A G, assignee. Scanning device for scanning dental objects and a method for scanning dental objects. United States patent application publication no. US 2011/0090513 discloses scanning device for scanning dental objects having a base plate to which dental objects can be attached and a mounting structure such as a mounting plate to which an optical scanning system is attached and means for moving the mounting structure. Furthermore, a method for scanning dental objects includes the steps of (a) attaching a dental object to the base plate of the scanning device, wherein a first angle between the surface of the base plate and the surface of the mounting structure is enclosed or the plane defined by the optical axes of the scanning device, (b) scanning the attached dental object to obtain a first data set, (c) using the means for moving the mounting structure to change the first angle to a second angle, and (d) scanning the attached dental object to obtain a second data set.

Rubbert R, Weise T, Sporbert P, Imgrund H, Kouzian D, inventors: Orametrix Inc, assignee. Methods for registration of three-dimensional frames to create 3D virtual models of objects, U.S. Pat. No. 7,027,642. 2006 Apr. 11 discloses a method and system are provided for constructing a virtual 3D model of an object using a data processing system, and at least one machine-readable memory accessible to the data processing system. A set of at least two digital 3D frames of portions of the object are obtained from a scanner or other source comprising a set of point coordinates in a 3D coordinate system providing differing information of the surface of the object. The frames provide a substantial overlap of the represented portions of the surface of the object, but do not coincide exactly. Data representing the set of frames are stored in the memory and processed by the data processing system so as to register the frames relative to each other to thereby produce a 3D virtual representation of the portion of the surface of the object covered by the set of frames.

Pulido A F, Garcia D D, inventors: Apollo Oral Scanner LLC, assignee. Dental scanner device and system and methods of use. U.S. Pat. No. 8,989,567. 2015 Mar. 24 discloses a 3D scanner device for generating a 3D surface model of shaped objects, such as dental structures, applicable for use in the field of dentistry, particularly to dental prosthetics manufacturing. Methods and systems relating to the device are also disclosed.

JP2015136615A provides an intraoral fixed type 3D oral cavity scanner that allows a user to easily acquire 3D images of the teeth and gums and acquire high-quality 3D images of the teeth and gums even when the patient moves, and that can be easily used even by unskilled persons. An intraoral fixed type 3D oral cavity scanner 100 includes: a housing 110 that can be located within an oral cavity of a patient; a photographing unit 120 that is coupled to the housing and photographs part of the patient's teeth; and a fixing portion 130 that is extended from the housing and that is bitten by the patient, so that the housing is fixed within the oral cavity.

KR101852834 discloses a 3D scanner that includes: a lens unit having a 360-degree angle of view; And an image processing unit for receiving a pattern image from a subject irradiated with a pattern and generating a 3D image of the subject based on the pattern image.

Moon J B, inventor: DDS Co, assignee. 3D scanner and artificial object processing device using the same. U.S. Pat. No. 10,792,133. 2020 Oct. 6 discloses a 3D scanner according to an embodiment of the present invention includes a pattern generating device irradiating a light pattern to a subject and an imaging device receiving an omnidirectional image of the subject to which the light pattern is irradiated.

Logozzo, Silvia, et al. “Recent Advances in Dental Optics—Part II: Experimental Tests for a New Intraoral Scanner.” Optics and Lasers in Engineering, vol. 54, Elsevier Ltd. 2014, pp. 187-96, doi:10.1016/j.optlaseng.2013.07.024 explains testing the performance of a new device for 3D oral scanning: a two-channel PTOF (pulsed time-of-flight) laser scanner, designed for dental and industrial applications in the measurement range of zero to a few centimetres. The application on short distances (0-10 cm) has entailed the improvement of performance parameters such as single-shot precision, average precision and walk error up to mm-level and to μm-level, respectively. The single-shot precision (a-value) has resulted in ranging from 43 to 63 ps (9-10 mm), having considered the measurement range (6.5-10 mm) corresponding to 1-2V signal; this result agrees well with estimates made from simulations. The average precision has resulted in being dependent on the number of measurements and can reach a value equal to ±25 μm whenever the measurement frequency is sufficiently high. For example, if the required scanning speed is 1000 points/s and the required average precision is ±25 μm, then a pulses frequency of 30-50 MHz is needed, considering signal amplitude varying between 1-2V. On the whole, the performance of this new device, based on PTOF has proven to be adequate to its employment in the field of restorative dentistry.

Maddahi, Y., Kalvandi, M., Maddahi, A, and Dhannapuneni, P. R., Tactile Robotics Ltd, 2022. Automated Measurement Apparatus and Method for Quantifying Dimensions of Dental Preparation. U.S. patent application Ser. No. 17/700,823 discloses an automated measurement apparatus that has a tooth holder receiving a tooth and a measurement sensor that senses a measured distance to a corresponding surface portion of the tooth. Linear and rotational actuation assemblies support the measurement sensor and the tooth holder for translating and angular relative movement. A controller operates (i) the rotational actuation assembly to locate the tooth holder relative to the measurement sensor in one or more angular orientations and (ii) the linear actuation assembly to displace the measurement sensor through an array of measurement locations within a measurement plane to capture the measured distance at each array location at each angular orientation and thereby define a geometry of the tooth surfaces. The controller may define the geometry subsequent to a dental preparation alteration of the tooth and through manual manipulation by a user can calculate an alteration metric representing one or more aspects of the defined geometry for comparison to a target metric.

### SUMMARY OF THE INVENTION

This invention pertains to a system for measurement, analysis, and grading, specifically designed to quantify the dimensions of teeth (dental preparations) either after completing or during a dental operation. The system and method may be used to report several characteristics of dental preparations including the volume, dimensions, density, mass, and different views of one or more teeth after the completion of a dental operation to assess the performance skills and methods of dental trainees using an automated measurement system. More specifically, it involves a method for evaluating the dental skills of trainees using an automated measurement system and associated methods, wherein:
(i) The automated measurement system is connected to a computer used by either the trainee or the trainer, linked to a dental scanner, and is operated via software to automatically measure the dimensions of dental preparations before (pre-op) and after (post-op) a dental procedure.
(ii) The system is employed to capture the geometry of the dental preparation and compare the geometry of a tooth or multiple teeth by analyzing the dimensions captured in both pre-op and post-op situations.
(iii) The tooth or group of teeth is located inside the automated measurement system in a given configuration recommended in the software.
(iii) The software application facilitates the connection between the automated measurement system at the trainer's workstation and each trainee's workstation, allowing for the transfer of measured geometry in real-time or offline between workstations.
(iv) The software manages the system's hardware and performs necessary calculations to produce three-dimensional and two-dimensional renderings of the collected data.
(v) Teeth or groups of teeth are positioned within the automated measurement system in a specific orientation as directed by the software; Trainees or trainers utilize a dental adapter connected to a dental typodont during scanning.
(vi) The system and its software include a dental rubric with various criteria for assessing or grading dental preparations.

The students can get quantified feedback on their dental work and skills, and are able to understand, learn, and practice while continuous feedback is provided by the automated measurement system with or without the presence of their instructor. This system could be used in a classroom, dental laboratory, dental clinic, or at a remote location. Another application of this technology is to assess the performance skills of practicing dentists after the completion of a dental procedure, in either clinics or continuing education courses. When apprentices have access to an apparatus that provides automatic measurements of dental preparations, the time required for training and the resources needed are reduced. Additionally, such an apparatus can enhance training efficiency and offer realistic feedback on each apprentice's dental skills.

Understanding tooth morphology and anatomy is crucial in dentistry, as crown morphology is vital in restorative and prosthodontic treatments, while external root morphology impacts the success of oral surgery, periodontal treatments, orthodontic treatments, and prosthodontic treatments. This invention allows dental trainees to receive precise feedback on their dental preparations and skills, enabling them to learn and practice with ongoing feedback from the automated measurement system, with or without their trainer's presence. The system can be utilized in classrooms, dental labs, clinics, or remote locations, and is also applicable for assessing the skills of practicing dentists after completing dental preparation in clinical settings or continuing education courses.

According to one aspect of the invention there is provided a scan adapter, for scanning a dental training model including a base arranged to support one or more teeth therein, using a scanning device to generate a three-dimensional object file defining said one or more teeth, the scan adapter comprising:
a mounting body arranged for mounting onto the dental training model at a prescribed mounting location relative to the one or more teeth of the dental training model; and
a set of scannable features on the mounting body having a known spatial relation to the prescribed mounting location on the dental training model;
wherein the set of scannable features comprise geometric patterns configured with identifiable geometry to enable recognition by image processing of the three-dimensional object file for identifying the one or more teeth of the dental training model by the spatial relation between the one or more teeth and the set of scannable features in the three-dimensional object file.

The adapter can be attached to the dental training model, or typodont, for calibrating the scanning process and capturing data from various types of intraoral or single-tooth scanners. Preferably the set of scannable features includes at least four scannable features. The scannable features may be in non-protruding relation to a bite surface of the one or more teeth of the dental training model. Preferably the mounting body is arranged for releasable mounting onto the base of the dental training model.

According to another aspect of the present invention there is provided a method of use of the scan adapter for assessing a dental preparation of at least one tooth of a dental training model, in which the method preferably includes the steps of (i) releasably attaching the mounting body of the scan adapter onto the dental training model, and (ii) scanning the dental preparation to produce a three-dimensional object file defining said one or more teeth and the scannable features of the scan adapter for identifying the one or more teeth of the dental training model by the spatial relation between the one or more teeth and the set of scannable features in the three-dimensional object file.

According to another aspect of the present invention there is provided a method of assessing a dental preparation of at least one tooth of a dental training model, the method comprising:
scanning the dental preparation to produce a preparation object file defining three dimensional surfaces of said at least one tooth; and
using an assessment system comprising a processor and a memory storing programming instructions thereon arranged to be executed by the processor so as to be configured to:
   process the preparation object file to determine an identity of said at least one tooth of the dental training model within the preparation object file; and
   calculate a grading report of the dental preparation of the at least one tooth by comparison to a reference object file defining three dimensional surfaces of at least one reference tooth stored on the assessment system in association with the identity of said at least one tooth; and
receiving the grading report from the assessment system.

According to a further aspect of the present invention there is provided an assessment system for assessing a dental preparation of at least one tooth of a dental training model, the system comprising:
a processor and a memory storing programming instructions thereon arranged to be executed by the processor so as to be configured to:
   acquire a preparation object file defining three-dimensional surfaces of said at least one tooth;
   determine an identity of said at least one tooth of the dental training model within the preparation object file; and
   calculate a grading report of the dental preparation of the at least one tooth by comparison to a reference object file defining three-dimensional surfaces of at least one reference tooth stored on the assessment system in association with the identity of said at least one tooth.

The assessment system may be configured to identify the one or more teeth of the dental training model by identifying a set of scannable features in the preparation object file and using a known spatial relation between the one or more teeth and the set of scannable features.

The assessment system may include an artificial intelligence based identifying algorithm arranged to identify said at least one tooth in the preparation object file by comparison of the preparation object file to a database of training object files defining respective three-dimensional surfaces of known teeth.

The assessment system may be configured to select said reference object file from a plurality of reference object files stored on the assessment system at least in part by user data input into the assessment system.

The assessment system may be configured to select said reference object file from a plurality of reference object files stored on the assessment system at least in part by features identified in the preparation object file by the assessment system.

The assessment system may be configured to (i) calculate at least one preparation border on the preparation object file comprising a set of points extending across a surface of the preparation object file to represent a prescribed alteration of the dental preparation and (ii) use said at least one preparation border in the comparison to the reference object file to calculate the grading report.

The assessment system may be configured to calculate said at least one preparation border at least in part using mathematical analysis including spatial analysis, geometric properties, and surface continuity.

The assessment system may be configured to calculate said at least one preparation border at least in part using an artificial intelligence based border detection algorithm that compares the preparation object file to a database of training object files defining three dimensional surfaces with determined preparation borders associated therewith.

The assessment system may be configured to apply a rule-based detection algorithm using geometric edge detection, curvature gradients, and minimum/maximum thresholds as a fallback in the absence of a trained artificial intelligence model.

The assessment system may be configured to calculate the grading report such that the grading report includes a graphical display of the preparation object file modified to display said at least one preparation border identified thereon.

The assessment system may be configured to (i) select said reference object file from a plurality of reference object files stored on the assessment system in which said reference object file includes a corresponding reference border associated therewith and (ii) calculate the grading report such that the graphical display of the grading report further displays reference object file with the corresponding reference border thereon together with the modified preparation object file.

When said reference object file includes at least one corresponding reference border associated therewith, the assessment system may be configured to calculate the grading report by calculating an alteration measure between said at least one preparation border on the preparation object file and said at least one corresponding reference border of said reference object file.

The assessment system may be configured to calculate said alteration measure for each criterion among a plurality of criteria identified in a rubric stored on the assessment system.

When the assessment system includes a user interface to receive user selections, the assessment system may be configured to reconfigure the criteria of the rubric in response to user selections through the user interface.

When the rubric defines a target range for each criterion, The assessment system may be configured to calculate the grading report for each criterion to (i) calculate a score based on alignment of the alteration measure with the target range, and (ii) generate a graphical representation in the grading report representative of said alignment of the alteration measure with the target range.

The assessment system may be configured to calculate at least one similarity measure between the preparation object file and a target object file in which the target object file defines three-dimensional surfaces of a related object stored on the assessment system in association with the identity of said at least one tooth.

The assessment system may be configured to (i) store the preparation object file and said at least one similarity measure in association therewith as part of a time series of previously stored preparation object files relating to previously produced dental preparations, and (ii) calculate a performance trend report based on variation of the similarity measures over said time series.

The assessment system may be configured to calculate the grading report such that the grading report includes an overlay image file in which the overlay image file comprises a three-dimensional graphical display of the preparation object file modified with the target object file overlayed thereon.

The assessment system may be configured to generate the overlay image file using color or shading to distinguish between over reduction regions in which the preparation object file is recessed relative to the target object file and under reduction regions in which the preparation object file protrudes relative to the target object file.

The assessment system may be configured to calculate the similarity measure at least in part using an artificial intelligence based similarity algorithm which is configured to measure similarity between the preparation object file and the at least one target object file using a database of training target object files.

When the at least one tooth of the dental preparation comprises a plurality of teeth, the assessment system may be configured to calculate the grading report for each identified tooth.

The system may be further configured to process preparation object files comprising multiple teeth and calculate grading reports for each identified tooth therein.

### BRIEF DESCRIPTION OF THE DRAWINGS

Some embodiments of the invention will now be described in conjunction with the accompanying drawings in which:

FIG. 1 illustrates the networked system architecture of the system, enabling dynamic communication between workstations;

FIG. 2 is a schematic overview of hardware and software components integrated within the system according to the present invention;

FIG. 3 is a perspective view of a set of scan adapters for mounting on to dental training models, or typodonts, to assist in calibrating and aligning scanned object files with other object files having known coordinate systems;

FIG. 4A is a three-dimensional graphical representation output by the system relating to the scanned preparation object file overlaid with a target object file, for example prepared by an instructor;

FIG. 4B is a further graphical representation output by the system illustrating the calculated reduction border of the dental preparation in comparison to a relevant border of a reference object file relating to an intact tooth structure, for example in a buccal view;

FIG. 5A is a screenshot of a grading interface illustrating a rubric template within the system software, displaying various customizable criteria for preparation assessment;

FIG. 5B further illustrates aspects of the rubric customization for buccal cusp reduction using the system with visual scoring scales and automated calculation of reduction depth;

FIG. 6 is a screenshot of a rubric management and sharing interface of the system, allowing instructors to share and distribute standardized evaluation templates;

FIG. 7A is a partial screenshot of a student grade manager interface of the system, enabling instructors to view, grade and track individual student submissions;

FIG. 7B is a further screenshot of a grading interface of the system displaying automatic and manual evaluation of a student's crown preparation, with calculated scores in visual alignment of preparation margins using a graphically displayed range;

FIG. 8 is a screenshot of a course set up and model import interface of the system, enabling file integration from various scanners for evaluation and grading;

FIG. 9A is a graphical output of the system illustrating a calibration view of an acquired preparation object file of a scanned dental preparation, used for aligning digital tooth models prior to evaluation;

FIG. 9B is a graphical output of the system illustrating the calibration results view in the system calibrator, showing proper alignment of an occlusal preparation scanned for evaluation;

FIG. 10A is a graphical output of the system illustrating a three-dimensional alignment view of a preparation object file relating to a dental preparation with respect to a reference to of the system, displaying spatial alignment using X, Y, and Z axes;

FIG. 10B is a graphical output of the system illustrating a finalized result of the trimming process, isolating the prepared tooth for focused analysis and grading; and

FIG. 11 is a schematic representation of the procedure for importing a three-dimensional object file.

In the drawings like characters of reference indicate corresponding parts in the different figures.

### DETAILED DESCRIPTION

The quality of immediate dental grading, assessment of dental preparation, and the anticipated therapeutic outcome depends on various factors, including the precision of the preparation and adherence to necessary dimensions. Before a procedure, dental trainees must perform a quantitative analysis of several tooth indexes relevant to the treatment, such as hard tissue indexes including axial reduction, buccal/vestibular-gingival reduction, palatal/lingual-gingival reduction, buccal/vestibular-occlusal reduction, palatal/lingual-occlusal reduction, isthmus width reduction, buccal/mesial/distal/palatal shoulder reduction consistency in reductions, line angles, convergence angle (taper), smoothness of prepped surfaces, and axial wall reduction. Accurate measurement of these indexes is crucial for the quality of learning, planning treatment, and efficient use of time and energy. Relying solely on subjective experience can lead to inconsistent interpretations and affect the formulation of a treatment plan. Additionally, due to the time constraints of dental trainers, providing detailed and consistent feedback to students is challenging, hindering their preparedness for actual dental practice. Thus, there is a vital need for a system that offers anytime, anywhere access for dental trainees to prepare and self-assess.

The patent describes an automated measurement system that provides precise measurements of one or more teeth for dental professionals, including dental instructors and practicing dentists. This system is designed to assess the dental skills of students or apprentices, addressing the challenges of precision and time efficiency in measuring and grading tooth preparation by leveraging artificial intelligence and data analysis techniques.

The system can be deployed at workstations for both trainees and trainers, functioning either as a standalone platform or integrated with other systems. Each workstation includes software that presents measurements, dimensions, images, and statistical and graphical information related to the trainee's dental performance during procedures. While the same automated measurement system is utilized at both types of workstations, the software may vary.

Key components include a dental typodont adapter for calibrating the scanning process and capturing data from intraoral or single-tooth scanners. The system also features three-dimensional graphical presentations and various two-dimensional views of the tooth, allowing for precise and accurate measurements of tooth geometry in relation to a base frame. This enables trainees to assess their skills, prepare for procedures, and compare their work with that of their trainers or with an intact (healthy) tooth. The system can also be used independently of the trainer's workstation for practice or training purposes.

The present invention provides a comprehensive software-based system designed for the assessment of dental preparations on single or multiple teeth. This system is particularly beneficial in dental education and training, offering advanced tools for evaluating the precision and quality of dental work performed by students or professionals.

System Components and Features include:

1. 3D Model Import Feature: The system supports the importation of various 3D model formats, including STL, PLY, OBJ, and others. These models can represent a wide range of dental preparations, such as crown prep, restorative prep (Classes I-VI, Inlay, Onlay), and bridging. This feature allows for a detailed analysis of different dental procedures.

2. Artificial Intelligence (AI)-Powered Border Detection Mechanism: Utilizing artificial intelligence, the system accurately identifies edges and surfaces of teeth within the 3D models. This precise detection is crucial for analyzing the boundaries of dental preparations.

3. View Determination System: The system establishes the correct orientation of teeth on jaws or other holders using at least four reference points. These reference points can be detected or measured using various devices, including 3D scanners, ensuring accurate alignment of the models.

4. Occlusion Effect Analysis Module: This module simulates and visualizes the interaction between upper and lower dental arches, evaluating the impact of dental preparations on bite alignment. It helps in assessing the functional aspect of the dental work.

5. Health Assessment Feature: The system analyzes the condition of adjacent teeth to the prepared tooth using image analysis and data from the 3D models. This feature ensures that the health of surrounding teeth is considered during the evaluation process.

6. Report Generation Tool: It produces comprehensive statistical and image-based reports on student performance. Instructors can define rubrics for grading, and the system can generate customized reports that include both visual and quantitative data.

7. Similarity Check Feature: The system includes algorithms for comparing the geometric and structural similarities between different dental preparations. This feature helps in identifying patterns and assessing the consistency of the work.

8. AI-Powered Automatic Grading System: Machine learning models trained on a dataset of dental preparations provide automated evaluations, offering objective grading based on reference preparation.

9. Manual Grading Option: In addition to automatic grading, the system allows for manual evaluation of student work, with or without a reference preparation. This flexibility accommodates different teaching methods and preferences.

10. Multi-Instructor Grading Capability: The system supports grading by multiple instructors, facilitating collaborative assessment and comprehensive feedback.

11. Self-Assessment Tools: These tools enable students and instructors to qualitatively and quantitatively assess dental preparations. The system provides metrics and visualizations to support self-evaluation.

12. Comprehensive Library of Intact Teeth Models: Users have access to a digital library containing various typodonts, allowing for benchmarking and comparison of student work against standard models.

13. Self-Preparation Tools: The system includes guided exercises and tutorials, enabling students to practice and improve their skills independently.

14. AI-Powered Recommendation Engine: Based on the analysis of student performance, the system suggests specific areas for improvement, helping students to focus their learning efforts effectively.

15. Repeated Analysis and Comparison Feature: The system allows for multiple analyses of dental preparations, with the capability to compare work against intact teeth models, ensuring continuous learning and refinement.

16. Integration with Existing Platforms: The AI-powered tools and features can function independently or be integrated with existing dental education platforms, providing versatility in different educational settings.

17. Data Security and Privacy Measures: The system includes robust measures to ensure the protection of student and patient data, complying with relevant privacy regulations.

18. Customizable Report Formats: Reports can be customized and exported in various formats, including PDF, making it easy to share and archive information.

19. Versatile Use in Various Settings: The system is designed to be utilized in classrooms, preclinical laboratories, clinics, or remote locations, providing flexibility for different learning environments.

20. The system of Claim 1 through 18, wherein the volume, mass, density, and dimensions of the three-dimensional model for restoration material including crowns, amalgam filling, composite filling, and bridges, is calculated and reported.

21. Updatable Software: The software can be updated to include new features and improvements, adapting to emerging needs in dental education.

The invention utilizes a combination of manual and automatic detection of reference points to calibrate images such as 2D or 3D object files captures by dental scanners. The system generates a comprehensive dataset that can be used to classify and manage unstructured data. The scanned points are employed to automatically generate borders around teeth or multiple teeth, leveraging Artificial Intelligence (AI) algorithms to detect similarities in scans, referred to as the similarity index.

The system integrates a sensing-augmentation mechanism with a set of dental typodont adapters, a data transmission system, data storage, a data analysis system powered by artificial intelligence, and software for data capture, analysis, and visualization. This setup provides dental students with critical information, such as the dimensions of dental preparations, and enables visualization from different angles, enhancing their understanding of various dental procedures.

Each workstation—whether for trainers or apprentices—measures the dimensions of dental preparations in linear, planar, or spatial coordinates. The data can be reviewed locally by apprentices or transmitted to trainers for feedback. A graphical display presents the regressed model of the tooth preparation, allowing for thorough analysis and improvement of dental performance.

The figures illustrate the detailed setup and components of the system, including the processing system, scanning system, typodont, typodont adapter, control unit, data transmission system, feature of software, and more. The figures provide a visual understanding of how the system is assembled and how it functions to measure and analyze dental preparations.

Additional aspects of the system include: The system's sensory capabilities include proximity sensors, laser sensors, and various other technologies to measure distances and angles accurately. Actuation systems, including electromagnetic, hydraulic, pneumatic, and other types, provide precise movement control for the measuring sensor and tooth holder.

The invention encompasses methods for using the system in various dental procedures, including examination, endodontics, prosthodontics, operative work, restorative work, surgery, extraction, and periodontics. The system may be provided as a kit, including all necessary components and instructions for use.

This detailed description underscores the invention's innovative approach to dental education, leveraging advanced technologies to enhance the accuracy and efficiency of dental training and assessment. The system's adaptability, comprehensive features, and AI-driven capabilities make it a valuable tool in the evolving landscape of dental education.

The interface of the system allows users to set up courses and dental tasks along with the selection of the type of typodont, the specific tooth number, and features of viewing a three-dimensional model, connecting the software to the scanning device, uploading the scan results, setting up rubrics and grading students.

The system can generate a three-dimensional model of an intact tooth superimposed on the respective prep tooth generated by the system.

Relevant preparation borders for subsequent analysis may be detected via the Artificial Intelligence (AI) system on both prep and intact teeth and generated by the system.

In some instances, a measuring tool of the system can be used to calculate an alteration amount, that is to calculate a reduction by selecting two points, to calculate the convergence angle by selecting four points, or to calculate the consistency in reduction of prep tooth by choosing multiple points.

A rubric for grading is available to instructors through a suitable interface of the system to customize based on their needs. The rubric can be set up using a prep tooth to be used as a reference for automatic grading of students later. The procedure of automatic grading of students' dental preparations are based on the rubric created by the instructor. A manual grading feature is also available. Instructors also have access to a grading window allowing instructors to create the rubric and compare the measurements for sanity check.

The system can also generate a graphical output comprising an overlay of the instructor's prep over the students' prep to determine the deviations and differences between the preps. This feature is also available for students when logging into the software via a student's account.

The invention enhances traditional marking and grading systems in dental education by integrating a sensing-augmentation system. This system includes a set of dental typodont adapters, a data transmission system, data storage, a data analysis system powered by artificial intelligence, and software to capture, analyze, and visualize data. It provides dental, dental assistance, and dental hygiene students with essential information, such as the dimensions of dental preparations once a dental task is completed. It also offers different angles of view captured by the sensory system, enabling students to visually assess their skills in various areas, including examination, restorative, periodontal, prosthodontic, extraction/surgical, orthodontic, and endodontic procedures.

The automatic measurement system utilizes dental typodont adapters to calibrate and initialize the dental scanning system, which reads the 3D coordinates of points on each tooth surface. A data processing unit receives these measured coordinates, and a data training system, incorporating various algorithms including those driven by artificial intelligence, processes the data. The information is then transmitted to an automatic measurement system at the trainer's workstation, whether in a classroom, preclinical laboratory, or remote location such as a home. In addition to the trainer's workstation, apprentices can view their results on local software before submission.

The measurement system includes a process for calculating reduction borders, that is prep border line generation and preparation area detection. The generation of preparation border lines and detection of the prep area (whether for a single view or multiple views of one or more teeth) is performed using advanced computational methods. This includes: (i) Mathematical Analysis, (ii) AI-Trained Algorithms, or (iii) a hybrid approach. The mathematical analysis leverages 2D/3D spatial analysis such as moving circle/sphere over the outer area of the 2D/3D points and relying on geometric properties such as curvature, slope, depth, angles and surface continuity to identify distinct margins on prepared and unprepared tooth structures. The AI-trained algorithms utilize machine learning models trained on a wide dataset of validated scans to detect borders with high accuracy, even in complex or variable conditions. In many cases, a hybrid approach is used, comprising a combination of both mathematical methods and AI-based inference to enhance precision, adaptability, and robustness across different tooth morphologies and scanning conditions.

Each apprentice and trainer may have their own automatic measurement system. The system at either workstation measures the dimensions of the dental preparation in linear, planar, or spatial coordinates. At the apprentice's workstation, these dimensions and the geometry of the dental preparation can be compared and analyzed to provide feedback. A display shows the regressed model of the tooth preparation recorded by the sensory system, allowing apprentices to understand and refine their dental performance before treating actual patients in a clinical setting.

In summary, the invention enhances the training, learning, and practice processes in dental education. It allows dental hygiene and dental students to visualize and compare their work with a standard dental preparation more quickly and effectively than traditional methods, which may involve direct marking by a trainer and are prone to human error.

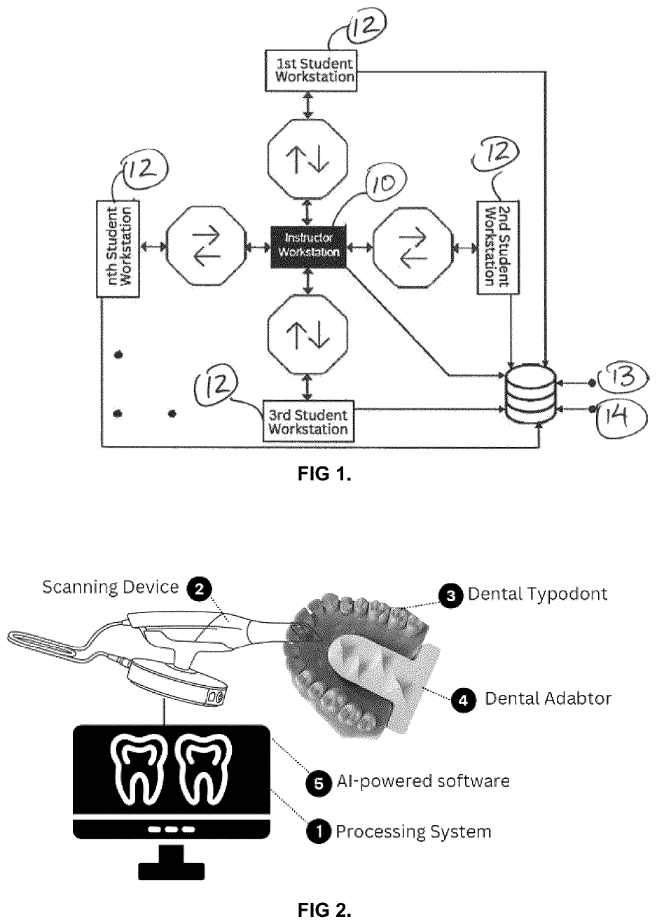

FIG. 1 represents the overall view of the system architecture. The instructor 10 is connected to students 12 via remote communications while both instructor 10 and students 12 are connected to the data storage system 13 and database 14. FIG. 1. illustrates the networked system architecture of the system, enabling dynamic communication between one or more instructor workstations and multiple student or trainee workstations (1st to nth). Each student workstation is connected to a system that captures detailed preparation data. This data is transmitted either via a local or cloud-based network to the instructor workstation for evaluation and feedback. Instructors can monitor and grade student performance in real time or asynchronously. The automated measurement system generally includes an apparatus for use by a trainer or a dental apprentice or a plurality of dental apprentices for use by individual trainees respectively. A suitable communication system or communications network provides communication between the trainer workstation and the apprentice's apparatus. The architecture presented in FIG. 1 supports a hub-and-spoke model where the instructor workstation serves as a central node facilitating bidirectional data exchange with student nodes. Additionally, all scanner-generated data is securely stored in a centralized or distributed database system for long-term storage, grading history, and analytics. Students can also independently access the platform for self-preparation and self-assessment using predefined rubrics and automated feedback tools. The system ensures scalable communication and supports individualized as well as group-based educational workflows.

FIG. 2 shows details of the scanning procedure. The processing unit includes the Artificial Intelligence (AI)-power software which is connected to the scanning device wired or wirelessly. The dental typodont is assembled on the dental adapter to be scanned by the scanning device. The scanning results can directly be transferred from the scanning device to said software or be imported in a 3D model format to said software. FIG. 2 presents an overview of the hardware and software components integrated within the system. The system consists of the following labeled elements. Processing System 1 is a computing unit responsible for data reception, processing, analysis, and display of 3D scanned models. It runs the grading engine and interfaces with both the scanning device and user. Scanning Device 2 is a handheld intraoral scanner used to capture high-resolution 3D images of the dental typodont. It transfers the scan data to the processing system. Dental Typodont 3 is a physical model of a human dental arch used for practice and assessment. This simulates real oral anatomy for students or trainees. Dental Adapter 4 is a specially designed mount that secures the typodont during scanning. It ensures accurate positioning, repeatability, and calibration within the scanning environment. AI-Powered Software 5 is a proprietary grading software integrated with artificial intelligence to analyze the scan data, compare it to reference standards, and generate feedback or scores based on predetermined rubrics. Together, these components enable real-time, objective assessment of dental preparations, supporting both instructor-led and self-guided training scenarios.

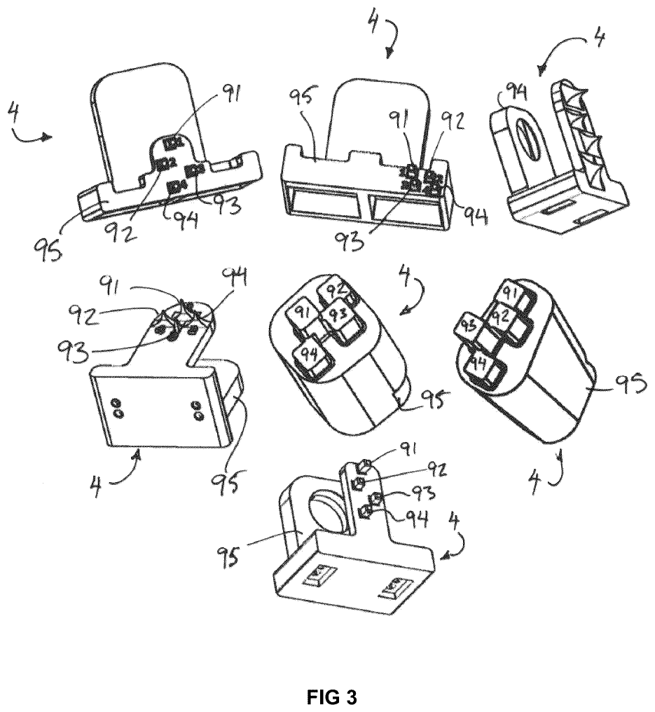

FIG. 3 shows various examples of the dental adapter 4 referred to in FIG. 2 containing at least four reference points 91, 92, 93, and 94 for calibrating the scan results. Said dental adapter comprises a connector 95 to fix said dental adapter 4 to said dental typodont 3.

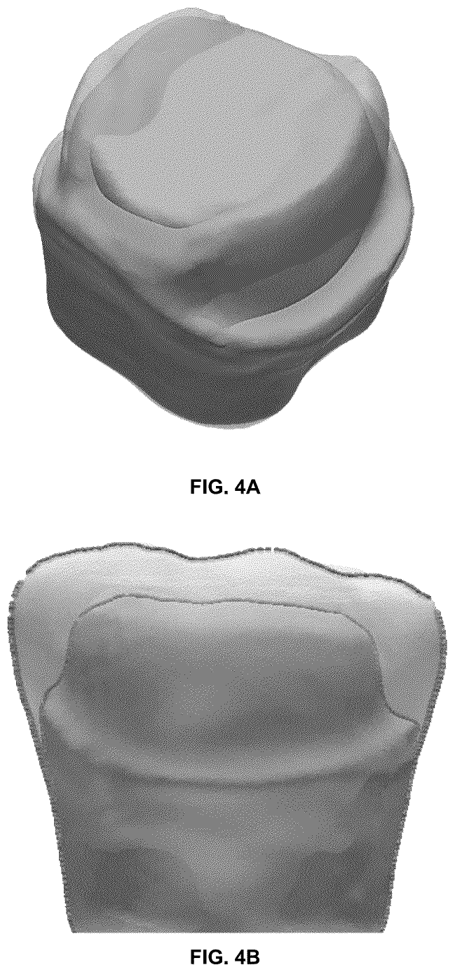

FIG. 4A illustrates the comparative analysis between a student-prepared tooth and the instructor's reference model using the system. The overlay highlights discrepancies in prep surface geometry, with color-coded regions indicating areas of under- or over-preparation. The alignment algorithm registers both models in 3D space, enabling precise measurement of deviations for objective feedback. This visualization is part of the system's grading process, offering quantifiable metrics for taper, convergence, and margin accuracy.

FIG. 4B demonstrates the system's automated detection of the preparation margin on a scanned tooth surface. The green lines represent the system-identified borders separating the prepared area from the intact tooth anatomy. Detection is achieved through a combination of curvature analysis, slope gradients, and AI-trained classifiers, enabling reliable and repeatable identification of preparation boundaries critical for grading and feedback in dentistry.

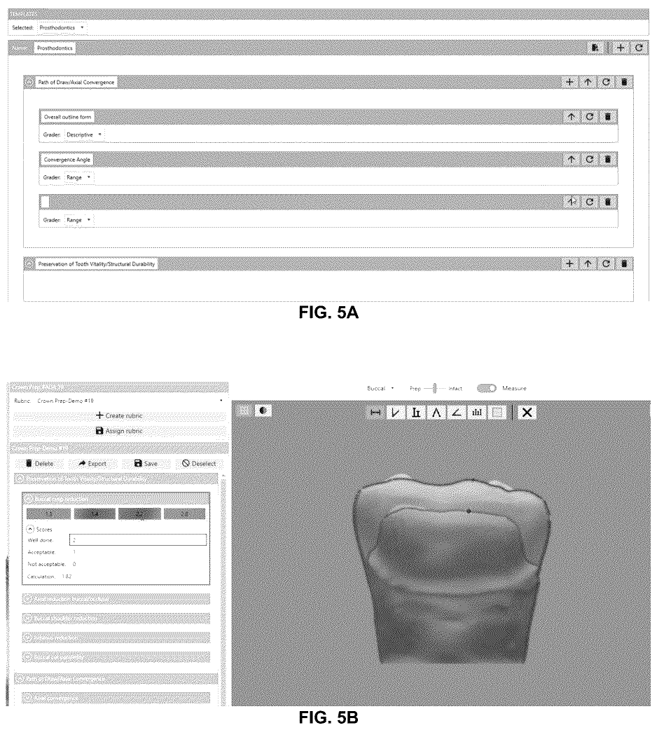

FIG. 5A shows the digital rubric configuration interface used in the system. Instructors can create, modify, and apply grading templates tailored to specific procedures such as prosthodontics. Each rubric includes categories such as path of draw, axial convergence, and structural preservation, with grading modes set to either descriptive or numeric ranges. The system supports real-time evaluation, standardized feedback, and faculty calibration through shared rubric templates, enhancing objectivity and consistency in dental education.

FIG. 5B illustrates the rubric-driven grading interface within the system. The rubric titled “Crown Prep-Demo #19” includes a measurement for buccal cusp reduction under the category Preservation of Tooth Vitality/Structural Durability. A color-coded scoring bar indicates acceptable reduction ranges (green zone), with values outside the target range highlighted in orange or red. The system calculates an objective score (1.82 mm in this case) based on predefined thresholds and instructor-defined scoring levels (Well done, Acceptable, Not acceptable). The visual overlay on the 3D model highlights the preparation margin and supports detailed, quantifiable evaluation.

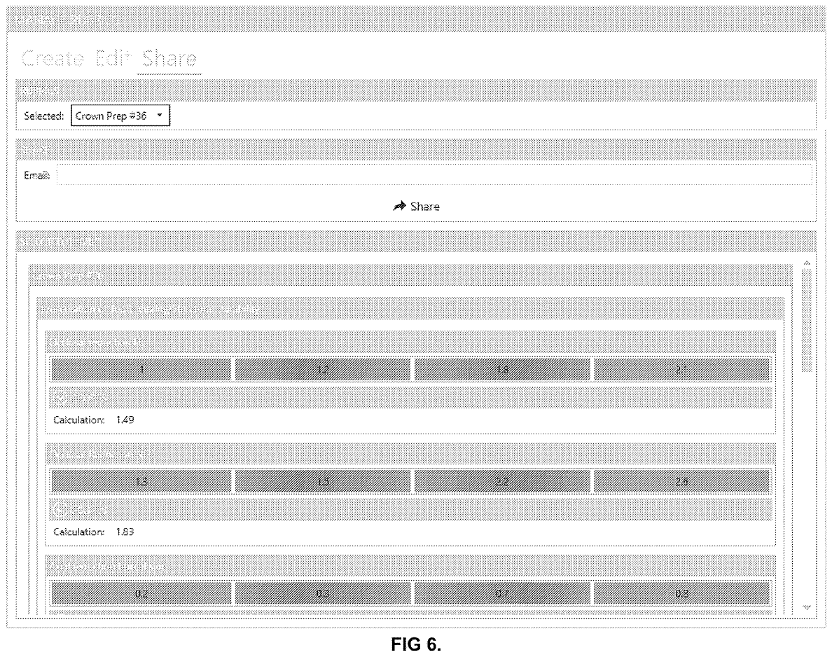

FIG. 6 displays the rubric sharing feature in the system software, enabling educators to manage and disseminate standardized grading templates across courses or departments. The selected rubric, “Crown Prep #36,” includes quantitative evaluation parameters such as occlusal and axial reduction. Each criterion is associated with a color-coded scale indicating acceptable measurement ranges. The sharing module allows instructors to input an email and send the rubric directly, supporting consistent grading, faculty calibration, and multi-instructor teaching environments.

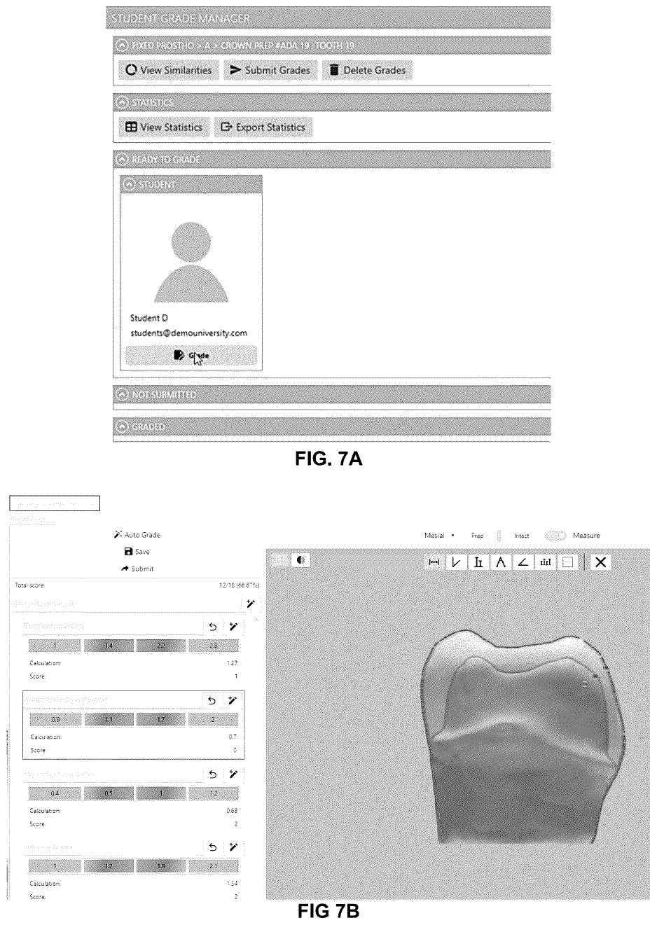

FIG. 7A presents the Student Grade Manager screen within the software. Instructors can access and manage student submissions for specific procedures. In this example, Crown Preparation for Tooth #19. The interface allows for viewing similarities to instructor reference preps, submitting or deleting grades, and exporting detailed performance statistics. Each student is listed with associated metadata and a “Grade” button for initiating the evaluation process. This centralized dashboard supports efficient grading workflows, submission tracking, and data export for institutional reporting and performance review.

FIG. 7B illustrates the grading page in the system software for Tooth #19, using a custom rubric titled “Crown Prep-Demo #19.” Each criterion—such as buccal cusp reduction, axial reduction, and buccal shoulder reduction—is evaluated using color-coded tolerance bands. Scores are either auto-calculated or manually adjusted based on instructor input. On the right side, a 3D model shows the scanned preparation with highlighted margin lines and reference points. The interface supports both automated grading and manual overrides, enabling flexible, data-driven assessment tailored to the educational setting.

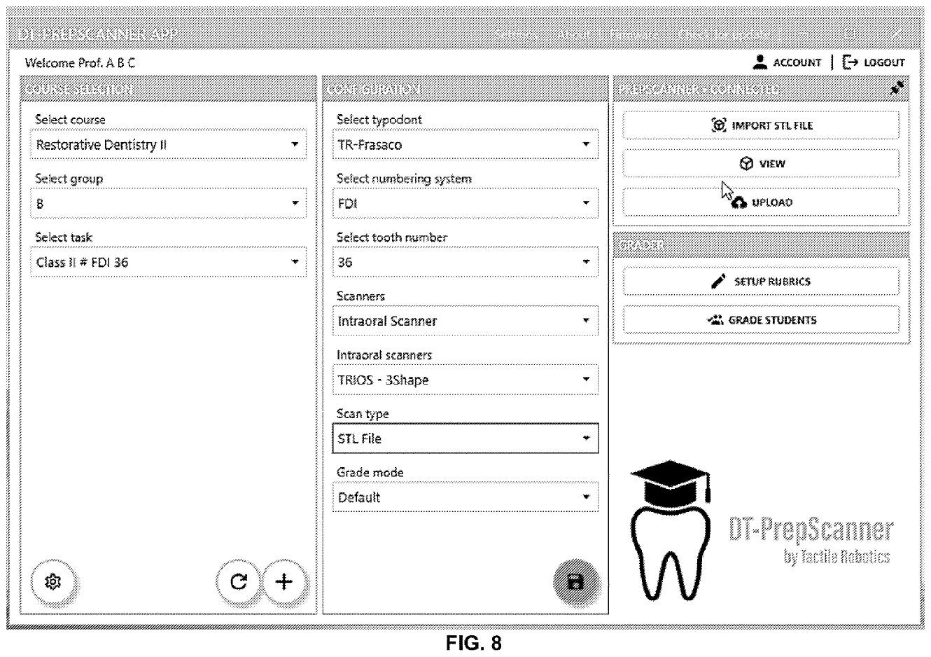

FIG. 8 shows the main configuration dashboard of the system app, where instructors can set up course details, define grading parameters, and import digital 3D tooth models. The user selects the course (e.g., Restorative Dentistry II), group, tooth number, and scanner type. The system supports 3D file imports from various intraoral scanners, such as 3Shape TRIOS. Once imported, the scan can be visualized, aligned, and evaluated using custom rubrics. The platform streamlines digital workflow integration by enabling seamless transition from real-world scanning to educational grading.

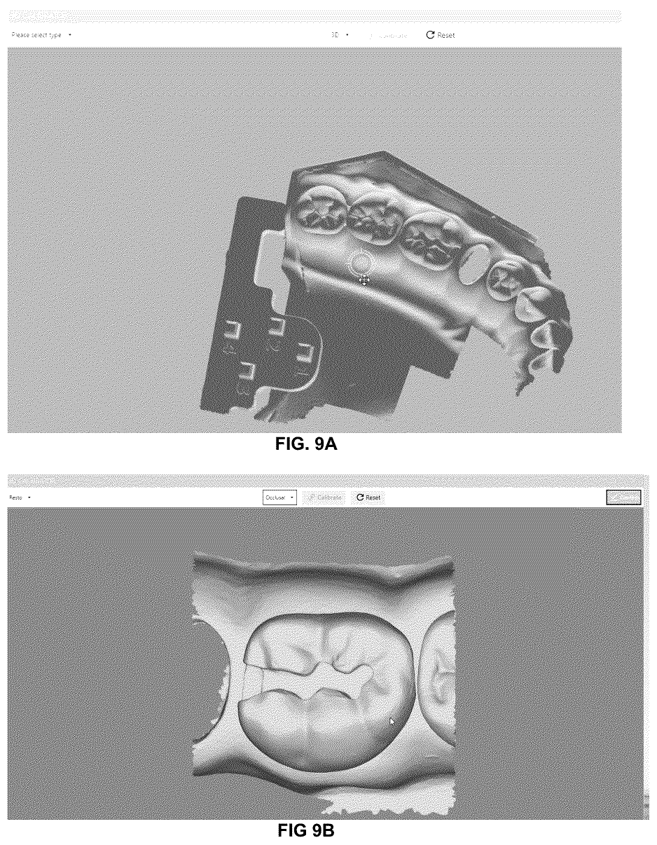

FIG. 9A illustrates the 3D calibration interface in the system, displaying an imported STL, PLY, OBJ, or other scan of an arch. Calibration ensures that the digital model is spatially aligned for accurate analysis and grading. The central targeting section indicates the calibration reference points. Calibration precedes all assessment tasks, allowing consistent comparison between student scans and instructor standards.

FIG. 9B displays the outcome of a successful calibration process within the PrepScanner platform. The 3D Calibrator has aligned the occlusal view of a Class II preparation, isolating the target tooth from the surrounding arch structure. This precise positioning is essential for accurate grading, as it ensures the system can apply rubrics and measurements consistently. The selected calibration mode (occlusal) enables detailed visualization of surface anatomy, margin lines, and prep geometry before assessment is confirmed and initiated.

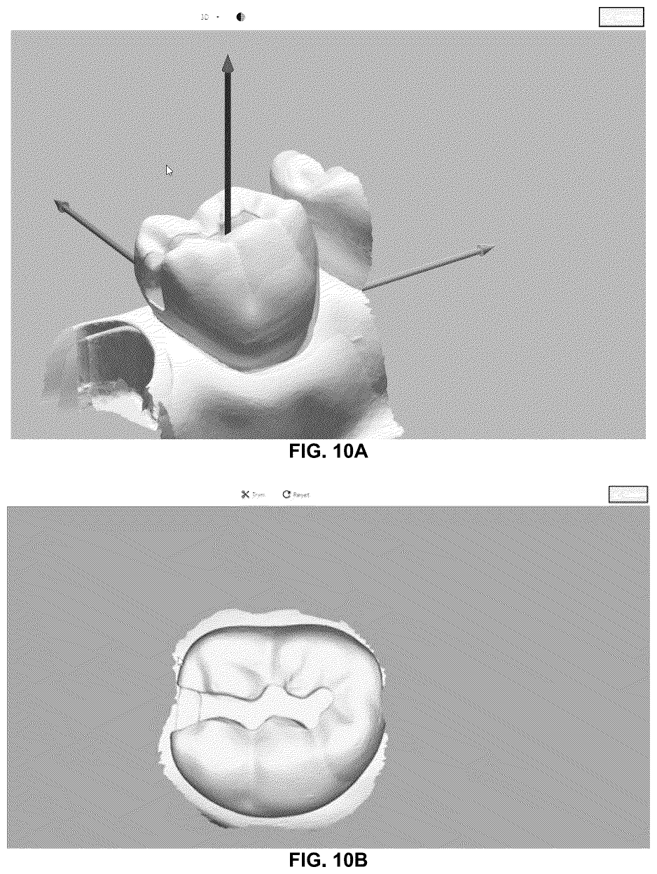

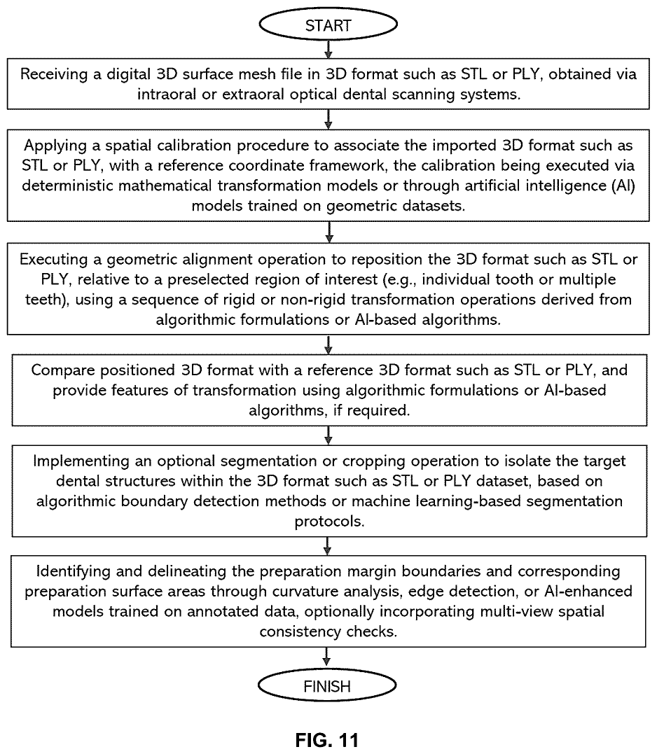

FIG. 10A illustrates the 3D spatial alignment process in the system application, where a reference tooth is visualized with coordinate axes for calibration and grading orientation. The red, green, and blue arrows represent the X, Y, and Z axes, respectively, enabling verification of the tooth's position and angulation in virtual space. This alignment is crucial for accurately comparing student preparations against standardized reference models, ensuring that measurements such as taper, convergence, and marginal integrity are evaluated relative to a consistent orientation.

FIG. 10B displays the trimmed 3D scan of a tooth preparation using the system software. The trimming function allows the user to isolate the region of interest, typically a single tooth or quadrant, by removing surrounding anatomical data. This step ensures that only relevant geometry is processed during evaluation, improving computational efficiency and grading accuracy. Once trimming is complete, users can proceed to confirm, calibrate, and analyze the preparation using predefined rubrics and visual tools.

The automated measurement and assessment system according to the present invention comprises one or more user computer devices which may communicate with a central server collectively defining a computer environment. The computer environment of the system includes (i) a processor defined by a single processing unit or a plurality of distributed processing units of the computer environment and (ii) one or more computer memories storing programming instructions thereon that are arranged to be executed by the processor to perform the various functions described herein. The computer memories may include one or more databases that store various object files used by the system in the process of assessing object files as described in the following. In each instance, when referring to an object file herein, the object file defines three-dimensional surfaces of a three-dimensional object, namely one or more teeth of a dental training model or typodont 3.

The databases include a plurality of stored reference object files used for comparison to the object files of the dental preparations to quantify the various alterations that have occurred in the dental preparation. The reference object files define the surfaces of intact, unprepared teeth of various types of typodonts and the object files are typically classified according to the type of typodont with which they are associated along with information about the identity of each tooth supported within the typodont including the relative coordinates and the relevant unaltered surfaces of each of the teeth of each typodont.

The database also includes a plurality of stored target object files, also used for comparison to the object files of the dental preparations to quantify the similarity between the dental preparations by student's and a relevant object that is related to the preparation by the student. In one example, this may represent a dental preparation by an instructor scanned into a target object file that represents an ideal amount of alteration or reduction according to a prescribed instructor or organization which forms the basis for some of the grading of the assessment system described in further detail below. Accordingly the target object files may be classified according to instructor or organization along with a rubric that defines various criteria which the system relies upon for grading a dental preparation by a student when comparing to a target object file designated by the instructor. The target object file may be generated electronically, or in a preferred instance may be generated by the instructor performing alterations or reductions on an instructor typodont which is then scanned and the target alteration amounts are calculated using various border detection algorithms described below that are the substantially the same as the algorithms used for border detection in dental preparations by students.

For a typical dental preparation, the rubric associated with a target object file defines a plurality of criteria in which each criterion includes a target reduction amount associated therewith and a corresponding range of acceptable values so that grading may be accomplished by alignment of a calculated alteration amount determined for a student dental preparation relative to the range associated with each criterion of the rubric as described in further detail below.

The system is commonly used with an adapter 4 which releasably mounts in fixed relation to the base of the typodont or dental training model 3. As shown in FIG. 3, although various configurations of the adapter 4 are envisioned, in each instance a main mounting body of the adapter defines a connector 5 that mounts onto the base of the typodont 3. Each adapter 4 also includes a set of scannable features 91, 92, 93, and 94 which are supported on the main body of the adapter and which have a known spatial relation to a prescribed mounting location of the mounting body on the typodont 3.

As the mounting body of the adapter 4 is always mounted at the same prescribed mounting location relative to the base of the typodont 3, the adapter serves to define a spatial relationship and known coordinates between the scannable features and the relative position of the teeth mounted within the base of the typodont 3. The mounting location geometry may be precisely defined to ensure consistent positioning of the scan adapter on various dental models, enabling reproducible evaluations.

In the illustrated embodiments, the scannable features each have unique coordinates while being shaped in a manner that is readily identifiable by image processing of the resulting three-dimensional object file when scanning the typodont 3 with the adapter 4 mounted thereon. That is, the set of scannable features comprise geometric patterns configured with identifiable geometry to enable recognition by image processing of the three-dimensional object file for identifying the one or more teeth of the dental training model by the spatial relation between the one or more teeth and the set of scannable features in the three-dimensional object file.

The scannable features may include various identifiable geometries such as pyramidal, cylindrical, or polygonal shapes. In one embodiment, the scannable features comprise conical protrusions spaced at defined intervals, forming a unique spatial pattern that facilitates automatic recognition by 3D scanning and object detection software. The features within a given set may be identical to one another or different from one another in shape and configuration.

Four scannable features are selected as a minimum to ensure spatial redundancy and increases robustness to occlusion and alignment accuracy in determining spatial orientation in three dimensions, minimizing the likelihood of alignment errors during automatic model registration.

In some instances, the connector 5 is clamped onto the base of the typodont 3 at a central location nested within the arch defining a row of teeth of the typodont 3. In this instance, the scannable features may be located on the mounting body of the adapter 4 so that once mounted on a typodont 3, the scannable features are located in nested relation to the dental arch in a non-protruding manner relative to the biting surfaces of the surrounding teeth supported in an arch on the typodont 3 as shown in FIG. 2 for example.

In other instances, the mounting body of the adapter 4 defining a connector 5 has a base similarly shaped to the teeth that are releasably mounted within the base of the typodont 3 so that the adapter 4 mounts onto the base of the typodont 3 in the same manner that a conventional tooth of the typodont 3 is mounted into the base of the typodont. In this instance, the scannable features are formed at the distal surface of the mounting body relative to the base of the typodont 3. The scannable features may again be arranged in a non-protruding relation to the distal biting surfaces of the surrounding teeth of the typodont 3. In this manner, the scannable features are readily captured by various types of scanning equipment while minimizing any potential interference between the scanning device 2 and the scannable features when scanning a typodont 3.

Use of the system by a student typically involves the student initially performing a dental preparation on one or more teeth of the typodont 3 to reduce material from one or more surfaces of the one or more teeth.

Upon completion of the dental preparation, the user then mounts the adapter 4 onto the prescribed mounting location on the base of the typodont 3 followed by scanning of the typodont 3 together with the adapter 4 using the scanning device 2 to generate a preparation object file uploaded to the assessment system. The student that interacts with and uses the assessment system of the present invention to process the object file and receives a resulting grading report generated by the system.

The system can allow for scanning with and without the scan adapter 4, where the first scan supports alignment and the second scan is used for actual grading as described in further detail below, without visual obstruction.

Using a dashboard or interface similarly to the screenshot shown in FIG. 8, the user can also input various data to be associated with the object file that was uploaded such as selecting the type of typodont 3, either directly or in an inferred manner by selecting an associated instructor or organization, along with specifying the type of scanner used, the relevant teeth being prepared, and the associated file type for example. The user may also specify the type of preparation being performed.

The system is then capable of identifying which reference object file among the stored reference object files, and which target object file if applicable, should be used as a basis for various calculations and comparisons described in the following which form the basis of the subsequent grading report generated and communicated to the user by display or through an electronic communication for example. For identifying which reference and/or target object files should be selected from the database for a basis of comparison, the system can use the identifying information input by the user together with features in the scanned object file.

In some instances, identifying information that is scanned together with the typodont 3 and the adapter 4 may be used as inputs which the system can use to infer the identity of the one or more teeth that are applicable within the preparation object file that was scanned, so that the associated object files to be selected from the database as a basis of comparison can be at least in part based on recognition of the content in the preparation object file, including the type of dental preparation being performed.

In one example, the assessment system may include an artificial intelligence based identifying algorithm arranged to identify the one or more teeth in the preparation object file by comparison of the preparation object file to a database of training object files relating to known teeth and dental preparations. The identifying algorithm may include a convolutional neural network (CNN) trained using a dataset of STL, PLY, OBJ, or other files representing various tooth morphologies. The model outputs a probability map for each tooth type, enabling classification and preparation boundary detection.

Typically, a combination of user input information and the set of scannable features identified in the object file are collectively used to identify and isolate a portion of the scanned object file to be subsequently processed and assessed in later stages. Specifically, the set of scannable features and the known spatial relation between the teeth of the typodont 3 and the scannable features can be used to locate which portion of the scanned object file is relevant for subsequent analysis based on the identity of which one or more teeth are to be assessed.

As shown in FIG. 3, the system initially receives a digital 3D surface mesh file or object file in a 3D format such as STL, PLY, OBJ, or other obtained by the dental scanner. A spatial calibration procedure is then applied to associate the imported 3D format with a reference coordinate framework in which the calibration is executed for example by deterministic mathematical transformation models or through artificial intelligence models trained on geometric datasets. FIG. 9A illustrates an initial scanned object file including the typodont 3 and the scannable features of the adapter 4 onto which the spatial calibration procedure is applied.

The system then executes a geometric alignment operation to reposition the preparation object file relative to a preselected region of interest, for example an individual tooth or multiple teeth relevant to the dental preparation being assessed, using a sequence of rigid or non-rigid transformation operations derived from algorithmic formulations or AI based algorithms. The system then compares the positioned 3D format with a reference 3D format to provide features of transformation, again using algorithmic formulations or AI based algorithms as required. FIG. 10A illustrates the alignment of the coordinate system of the preparation object file of the dental preparation with the standard coordinates used by all the stored object files as represented by X, Y and Z axes being aligned.

An optional segmentation or cropping operation is then performed by the system to isolate the target dental structures within the 3D file format, based on algorithmic boundary detection methods or machine learning based segmentation protocols, resulting in a cropped object file of the isolated structure as the resulting preparation object file for subsequent analysis as shown in FIG. 10B.

Once the preparation object file has been prepared for subsequent analysis, the system identifies and delineates preparation margin boundaries and corresponding preparation surface areas through curvature analysis, edge detection, or AI enhanced models trained on annotated data, optionally incorporating multiview spatial consistency checks. In this manner the system is configured to calculate one or more preparation borders on the preparation object file in which each preparation border results in a set of points identified in the preparation object file corresponding to points on the surface of the object which are in sequence with one another across a prescribed surface of the preparation object file and which define a representative outline of a corresponding alteration or reduction performed by the student in the dental preparation.

In one instance, each preparation border calculated or the generation of each preparation borderline and detection of the prep area, whether for a single view or multiple views of one or more teeth, is performed using advanced computational methods. In one example mathematical analysis is performed leveraging 2D and/or 3D spatial analysis such as moving circle/sphere over the outer area of the 2D and/or 3D points and relying on geometric properties such as curvature, slope, depth, angles and surface continuity to identify distinct margins on prepared and unprepared to surfaces.

Alternatively, the assessment system may be configured to calculate the at least one preparation border using machine learning models trained on a wide dataset of validated scans to detect orders with high accuracy, even in complex or variable conditions. That is an artificial intelligence based border detection algorithm compares the preparation object file to a database of training object files defining three-dimensional surfaces of relevant objects with determined preparation borders associated therewith.

The same process, described for determining boundaries on the preparation object file uploaded by the student, have been previously used in determining corresponding preparation borders in target object files generated by instructors and stored for later use on the system. Preparation borders are calculated in association with each of the criterion of the relevant rubric which is also selected from the database based on the identification of the dental preparation to be assessed and various user selections or input data.

Once the scanned dental preparation, that is the preparation object file has been processed, and relevant preparation borders identified, the system can proceed to calculate a grading report of the dental preparation of the one or more teeth by comparison to the relevant reference object file and/or the relevant target object file selected from the database as a basis for scoring.

Although the target object file described above relates to a dental preparation by an instructor against which the preparation object file is compared, in other instances the target object file relative to which similarity measures are generated may be any other object file representing of a relevant dental preparation, such as a previous preparation by the student or a preparation by another student or individual other than the instructor. That is any other object file defining three dimensional surfaces that is stored on the system and is identified as a corresponding dental preparation may be used as a target object file as described herein.

The output usually includes (i) quantified information such as calculated scores that measure the accuracy of the alterations performed by the student relative to target alteration amounts derived from the target object file and/or criteria designated by the instructor in a stored rubric, and/or (ii) various graphical outputs to provide the student with visual feedback relating to their performance.

One of the outputs of the grading report includes modifying the preparation object file to include the calculated preparation borders thereon as shown in FIG. 4B for example. As also shown in FIG. 4B, the modified preparation object file generated can also include the preparation object file superimposed over a relevant reference object file with the relevant reference object file also being modified to include a relevant calculated reference border thereon. The image in FIG. 4B is generated by the system selecting the appropriate reference object file from the plurality of reference object file stored on the assessment system along with the corresponding reference border associated therewith, followed by calculating the grading report such that the graphical display further displays the reference object file with the corresponding reference border thereon together with the modified preparation object file.

The difference between the preparation borders of the modified preparation object file and the reference borders of the reference object file representing the intact tooth are used as a basis in calculating alteration amounts or preparation margins that forms the basis for some of the scoring.

The assessment system uses criteria from the relevant rubric to locate points representative of the alteration on the reference border which then in turn is used to locate corresponding points on the preparation borders of the preparation object file upon which the calculated difference or alteration margin is determined. The process of locating relevant points for calculating alteration margins is illustrated in FIG. 5B. Accordingly the system is configured to calculate alteration amounts or margins for each criterion among a plurality of criteria identified in a rubric stored in the assessment system.

Multiple different alteration amounts can be calculated and combined into a single score or grade.

The output for the calculated grading report can also include an overlay of the preparation object file compared to the relevant target object file illustrating the instructor's preferred surface alterations. This can be presented as an overlay image file comprising a three-dimensional representation of the overlaid preparation object file and the target object file as shown in FIG. 4A. The system may use different colours, patterns or shading to distinguish between (i) over reduction regions in which the dental preparation was overly reduced and the preparation object file is recessed relative to the target object file and (ii) under reduction regions in which the dental preparation was insufficiently reduced and the preparation object file protrudes relative to the target object file. That is, graphical overlays are used to visually distinguish over-reduction and under-reduction regions by color-coded mapping, generated from geometric deviation calculations between preparation and target reference files.

The outputs included in the grading report can also include a calculated similarity measure between the preparation object file and the target object file.

In one instance, the target object file includes relevant preparation borders representing alteration margins relative to the intact tooth of the corresponding reference object file. The instructor sets up the rubric so that the rubric defines a target range for each enabled criterion, that is each alteration amount to be specified and measured. For each criterion, in addition to calculating the relevant alteration amount based on the identified preparation border on the student's preparation object file, the preparation margins or alteration amounts are visually aligned with the prescribed target ranges and a score can be calculated based on the alignment of the student's alteration amounts with the relevant ranges.

In addition to displaying the points used as a basis for calculating an alteration amount on the relevant borders as shown in FIG. 7B, each of the target ranges for each preparation margin are also graphically represented with a visual indication of the alteration amount aligned with the target range to illustrate the basis of the scoring to the student.

Alternatively or in addition to the use of target ranges and calculated similarity between (i) the alteration amounts of the preparation object file relative to the reference object file, and (ii) the alteration amounts of the target object file relative to the reference object file, the system may also use an artificial intelligence based similarity algorithm to calculate the similarity measure, in which the similarity algorithm is configured to measure similarity between the preparation object file and the target object file using a database of training target object files.

The outputs generated as part of the grading report for each student preparation can also be stored as time stamped preparation object files associated with a particular student user. The time-stamped preparation image files for each user are used to compute trend data such as consistency of reduction, similarity improvement, and pass/fail performance across training sessions. The stored series of preparation 2D and/or 3D object files over time for a given user can be further used to calculate a performance trend report based on similarity measures across successive attempts. That is, as each dental preparation by a student is prepared and assessed, the resulting preparation object file and any associated similarity measures is stored as part of a time series of previously stored preparation object files relating to previously produced dental preparations, to enable calculation of the performance trend report based on variation of the similarity measures over said time series.

The screenshot in FIG. 5A represents an instructor interface through which the instructor can make rubric selections. The instructor interface is further elaborated upon in FIG. 6 in which the specified criterion of the rubric can be adjusted through user inputs. Specifically, the interface receives user selections and reconfigures the criteria of the rubric in response to the selections through the interface. The relevant target ranges associated with each criterion can also be graphically illustrated for the instructor during the rubric set up.

Optionally, the interface can also include a sharing function for sharing a configured rubric with another instructor or another user of the system.

The screenshot in FIG. 8 represents an instructor or dashboard through which various functions including rubric set up can be accessed as well as providing access for uploading target object files, and accessing grading for students.

In some instances, the system may be configured to receive a plurality of scanned preparation object files defining respective dental preparations, for example from different students, for processing as a batch. The identified teeth can be similarly assessed by performing similar comparisons to reference or target object files so that a grading report is calculated for each dental preparation through a single set of common instructions.

The system may use AI-based or data-driven models to evaluate the scanned preparation, enabling consistent and scalable assessments. In scenarios where AI-based models are unavailable, a geometric rule-based detection method is applied. This includes edge detection, surface curvature gradients, and predefined spatial thresholds. That is the assessment system is further configured to apply a rule-based detection algorithm using geometric edge detection, curvature gradients, and minimum/maximum thresholds as a fallback in the absence of a trained artificial intelligence model.

When referring to alterations of a dental preparation as described above, the alterations may refer to various types of dental procedures described in the following, and the metrics being evaluated as criteria in the instructor rubric will accordingly vary. Accordingly, in various embodiments of the system, many different dental tasks are supported and evaluated through quantitative metrics, herein referred to as Key Performance Indicators (KPIs). These KPIs enable precise assessment and feedback during training, simulation, and evaluation of manual dexterity and clinical competency. The system is designed to support restorative, prosthodontic, pre-clinical preparation, and diagnostic procedures by enabling automated grading based on 2D and 3D scan analysis.

Restorative procedures involve preparation of cavities or structures for the placement of restorative materials. Common operations include: Class I Cavity Preparation, Class II Cavity Preparation, Class III, IV, V and VI Preparations, Onlay and Inlay Preparations, and Composite and Amalgam Restorations. KPIs applicable to these tasks include: Cavity depth, width, and length, Internal line and wall angles and smoothness, Wall parallelism, undercuts, and roughness, and/or Distance from adjacent tooth and retention form.

Prosthodontic Preparations involve tooth reduction for prosthetic restorations such as crowns and bridges as follows: Full Crown Preparation (e.g., PFM, zirconia, gold), Partial Crown or Veneer Preparation, or Bridge Preparation (abutment teeth). The following KPIs are measured: Axial and occlusal reduction, Taper and convergence angles, Finish line type and location, Parallelism between abutments (for bridges), Occlusal clearance and smoothness of finish, External line angles, and/or Shoulder reduction shapes.

Preclinical Training Tasks include foundational manual dexterity tasks such as: Freehand depth control, Box or slot carving exercises, Simulated enameloplasty, and/or Outline form tracing. Relevant KPIs include: Precision of cut (spatial accuracy), Symmetry and uniformity, Tool alignment relative to defined axes, and/or Consistency of wall angles and floor depth.

Regarding Diagnostic Tasks, the system may also be extended to support identification and documentation procedures such as: Tooth charting, Periodontal probing simulation, and/or Digital imaging correlation. Although less dependent on cutting metrics, such tasks can still leverage the system's tracking for: Accuracy of contact point identification, Spatial mapping, and/or Recording of probing depth ranges.

Each dental task is evaluated using a consistent spatial reference system defined within the scan and rubric engine. Evaluation may be performed synchronously (in real-time) or asynchronously, with data visualization and annotated feedback provided via the platform's software interface. The system's automated grading algorithms compare performed tasks against ideal 3D geometries using cloud-hosted AI models and pre-defined tolerances set by instructors.

The following chart illustrates the applicable metrics to be measured and compared to other object files according to the dental task, for automatic grading and assessment according to the present invention.

| Dental Task/ | | |
|---|---|---|
| Operation | Category | Applicable KPIs |
| Crown | Prosthodontics | Reduction, Width, Depth, Length, |
| Preparation | | Finish Line Location, Taper, |
| | | Smoothness, Line Angles, Parallelity, |
| | | Distance from Adjacent Teeth |
| Veneer | Prosthodontics | Reduction, Width, Finish Line |
| Preparation | | Location, Smoothness, Line Angles |
| Inlay | Prosthodontics | Reduction, Depth, Width, |
| Preparation | | Smoothness, Finish Line Location, |
| | | Distance from Adjacent Teeth |
| Onlay | Prosthodontics | Reduction, Depth, Width, |
| Preparation | | Smoothness, Finish Line Location, |
| | | Distance from Adjacent Teeth |
| Bridge | Prosthodontics | Reduction, Finish Line Location, |
| Abutment | | Taper, Parallelity, Bridge Line, |
| Preparation | | Length, Smoothness, Distance from |
| | | Adjacent Teeth |
| Class I Cavity | Operative | Depth, Width, Smoothness, Distance |
| | Dentistry | from Adjacent Teeth, Line Angles |
| Class II Cavity | Operative | Depth, Width, Smoothness, Distance |
| | Dentistry | from Adjacent Teeth, Line Angles |
| Class III Cavity | Operative | Depth, Width, Smoothness, Distance |
| | Dentistry | from Adjacent Teeth, Line Angles |
| Class IV Cavity | Operative | Depth, Width, Smoothness, Distance |
| | Dentistry | from Adjacent Teeth, Line Angles |
| Class V Cavity | Operative | Depth, Smoothness, Distance from |
| | Dentistry | Adjacent Teeth |
| Endodontic | Endodontics | Depth, Smoothness, Line Angles, |
| Access | | Reduction |
| Margin Design | Prosthodontics | Finish Line Location, Smoothness, |
| | | Line Angles |

According to the present invention a software-based system is provided for assessing single-tooth or multiple-teeth dental preparations, comprising:
an import feature capable of handling various three-dimensional model formats, including STL, PLY, OBJ, and others, representing different types of dental preparations such as crown prep, restorative prep (including Class I, II, III, IV, V, VI, Inlay, Onlay), and bridging;
an AI-powered border detection mechanism for identifying edges and surfaces of prep and intact teeth in the two-dimensional and three-dimensional models;
a view determination system using at least four reference points to establish the correct orientation of teeth on jaws or other holders, detectable via various devices including three-dimensional scanners;
an occlusion effect analysis module for evaluating the impact of dental preparations on bite alignment;
a health assessment feature for analyzing the condition of adjacent teeth to the prepared tooth;
a report generation tool that produces statistical and image-based reports on student performance, including instructor-defined rubrics for grading;
a similarity check feature to assess similarities between different dental preparations;
an AI-powered automatic grading system for evaluating student work based on a reference preparation;
a manual grading option, with or without a reference preparation;
a feature of overlaying prep and intact teeth on top of one another to compare differences and reductions between teeth;
a multi-instructor grading capability for evaluating student performance using advanced techniques including artificial intelligence;
Self-assessment tools for students and instructors to qualitatively and quantitatively assess their work;
access to a comprehensive library of three-dimensional models of intact teeth from various typodonts;
features allowing for repeated analysis and comparison of dental preparations with intact teeth;
self-preparation tools for students to practice and improve their skills; and
an AI-powered recommendations system for generating improvement reports for students.

The AI-powered border detection mechanism provides detailed identification of various surfaces on a tooth model for accurate analysis.

The system includes a reference point detection feature capable of using a variety of devices, including three dimensional scanners, to identify the required reference points for accurate orientation, transformation and scaling.

The occlusion effect analysis module can simulate and visualize the interaction between upper and lower dental arches.

The health assessment feature utilizes image analysis and data from three dimensional models to evaluate the condition of adjacent teeth.

The system includes a customizable rubric tool for instructors to create specific criteria for grading student work.

The similarity check feature includes algorithms for comparing geometric and structural similarities between different dental preparations.

The AI-powered grading system uses machine learning models trained on a dataset of dental preparations and pre-determined rules to provide automated evaluations.

The system includes a module for enabling multiple instructors to review and grade a student's work collaboratively.

The self-assessment tools include metrics for both qualitative and quantitative evaluation of dental preparations.

The system includes access to a digital library of intact teeth models, allowing users to benchmark and compare their work.

The self-preparation tools include guided exercises and tutorials for students to practice independently.

The system includes an AI-powered recommendation engine that analyzes student performance and suggests specific areas for improvement.

The report generation tool can output detailed visual and statistical reports for both students and instructors.

The system includes a feature that enables the analysis of dental preparations to be performed multiple times, with comparisons made against a baseline of intact teeth models.

The AI-powered tools and features can function independently or be integrated with existing dental education platforms.

The system includes data security and privacy measures to ensure the protection of student and patient data.

The generated reports can be customized and exported in various formats, including PDF, for ease of sharing and record-keeping.

The volume, mass, density, and dimensions of the three-dimensional model for chairside restoration and lab-made restoration materials including crowns, amalgam filling, composite filling, and bridges, is calculated and reported.

The system is designed to be utilized in various settings, including classrooms, preclinical laboratories, clinics, or remote locations for flexible learning.

The system is designed to be utilized for artificial teeth such as plastic teeth, human and animal cadavers, or real teeth of a patient.

The software can be updated to include new features and improvements based on emerging dental education needs and technologies.

The invention may further relate to a method of use of the automated measurement system wherein the dental preparation includes the dental preparations required for examination, endodontics, prosthodontics, operative work, restorative work, surgery, extraction, or periodontics work. The procedure may include any one, or all, of piercing, cutting, and forming hard, and soft tissues.

The system may also be provided as a kit comprising the custom-designed dental articulator according to any aspect of the present invention noted above and a sheet of instructions for use thereof.

Since various modifications can be made in the invention as herein above described, and many apparently widely different embodiments of same made, it is intended that all matter contained in the accompanying specification shall be interpreted as illustrative only and not in a limiting sense.

1. A scan adapter, for scanning a dental training model including a base arranged to support one or more teeth therein, using a scanning device to generate a three-dimensional object file defining said one or more teeth, the scan adapter comprising:
a mounting body arranged for mounting onto the dental training model at a prescribed mounting location relative to the one or more teeth of the dental training model; and
a set of scannable features on the mounting body having a known spatial relation to the prescribed mounting location on the dental training model;
wherein the set of scannable features comprise geometric patterns configured with identifiable geometry to enable recognition by image processing of the three-dimensional object file for identifying the one or more teeth of the dental training model by the spatial relation between the one or more teeth and the set of scannable features in the three-dimensional object file.

2. The scan adapter according to claim 1 wherein the set of scannable features includes at least four scannable features.

3. The scan adapter according to claim 1 wherein the scannable features are in non-protruding relation to a bite surface of the one or more teeth of the dental training model.

4. The scan adapter according to claim 1 wherein the mounting body is arranged for releasable mounting onto the base of the dental training model.

5. A method of use of the scan adapter according to claim 1 for assessing a dental preparation of at least one tooth of a dental training model, the method comprising:
releasably attaching the mounting body of the scan adapter onto the dental training model; and
scanning the dental preparation to produce a three-dimensional object file defining said one or more teeth and the scannable features of the scan adapter for identifying the one or more teeth of the dental training model by the spatial relation between the one or more teeth and the set of scannable features in the three-dimensional object file.

6. A method of assessing a dental preparation of at least one tooth of a dental training model, the method comprising:
scanning the dental preparation to produce a preparation object file defining three dimensional surfaces of said at least one tooth; and
using an assessment system comprising a processor and a memory storing programming instructions thereon arranged to be executed by the processor so as to be configured to:
process the preparation object file to determine an identity of said at least one tooth of the dental training model within the preparation object file; and
calculate a grading report of the dental preparation of the at least one tooth by comparison to a reference object file defining three dimensional surfaces of at least one reference tooth stored on the assessment system in association with the identity of said at least one tooth; and
receiving the grading report from the assessment system.

7. The method according to claim 6 wherein the assessment system is configured to identify the one or more teeth of the dental training model by identifying a set of scannable features in the preparation object file and using a known spatial relation between the one or more teeth and the set of scannable features.

8. The method according to claim 6 wherein the assessment system includes an artificial intelligence based identifying algorithm arranged to identify said at least one tooth in the preparation object file by comparison of the preparation object file to a database of training object files defining respective three-dimensional surfaces of known teeth.

9. The method according to claim 6 wherein the assessment system is configured to select said reference object file from a plurality of reference object files stored on the assessment system at least in part by user data input into the assessment system.

10. The method according to claim 6 wherein the assessment system is configured to select said reference object file from a plurality of reference object files stored on the assessment system at least in part by features identified in the preparation object file by the assessment system.

11. The method according to claim 6 wherein the assessment system is configured to (i) calculate at least one preparation border on the preparation object file comprising a set of points extending across a surface of the preparation object file to represent a prescribed alteration of the dental preparation and (ii) use said at least one preparation border in the comparison to the reference object file to calculate the grading report.

12. The method according to claim 11 wherein the assessment system is configured to calculate said at least one preparation border at least in part using mathematical analysis including spatial analysis, geometric properties, and surface continuity.

13. The method according to claim 11 wherein the assessment system is configured to calculate said at least one preparation border at least in part using an artificial intelligence based border detection algorithm that compares the preparation object file to a database of training object files defining three dimensional surfaces with determined preparation borders associated therewith.

14. The method according to claim 13 wherein the assessment system is configured to apply a rule-based detection algorithm using geometric edge detection, curvature gradients, and minimum/maximum thresholds as a fallback in the absence of a trained artificial intelligence model.

15. The method according to claim 13 wherein the assessment system is configured to calculate the grading report such that the grading report includes a graphical display of the preparation object file modified to display said at least one preparation border identified thereon.

16. The method according to claim 15 wherein the assessment system is further configured to (i) select said reference object file from a plurality of reference object files stored on the assessment system in which said reference object file includes a corresponding reference border associated therewith and (ii) calculate the grading report such that the graphical display of the grading report further displays reference object file with the corresponding reference border thereon together with the modified preparation object file.

17. The method according to claim 11 wherein said reference object file includes at least one corresponding reference border associated therewith wherein the assessment system is configured to calculate the grading report by calculating an alteration measure between said at least one preparation border on the preparation object file and said at least one corresponding reference border of said reference object file.

18. The method according to claim 17 wherein the assessment system is configured to calculate said alteration measure for each criterion among a plurality of criteria identified in a rubric stored on the assessment system.

19. The method according to claim 18 wherein the assessment system includes a user interface to receive user selections and wherein the assessment system is configured to reconfigure the criteria of the rubric in response to user selections through the user interface.

20. The method according to claim 18 wherein the rubric defines a target range for each criterion, and wherein the assessment system is configured to calculate the grading report for each criterion to (i) calculate a score based on alignment of the alteration measure with the target range, and (ii) generate a graphical representation in the grading report representative of said alignment of the alteration measure with the target range.

21. The method according to claim 7 wherein the assessment system is further configured to calculate at least one similarity measure between the preparation object file and a target object file in which the target object file defines three-dimensional surfaces of a related object stored on the assessment system in association with the identity of said at least one tooth.

22. The method according to claim 21 wherein the assessment system is configured to (i) store the preparation object file and said at least one similarity measure in association therewith as part of a time series of previously stored preparation object files relating to previously produced dental preparations, and (ii) calculate a performance trend report based on variation of the similarity measures over said time series.

23. The method according to claim 21 wherein the assessment system is configured to calculate the grading report such that the grading report includes an overlay image file in which the overlay image file comprises a three-dimensional graphical display of the preparation object file modified with the target object file overlayed thereon.

24. The method according to claim 23 wherein the assessment system is configured to generate the overlay image file using color or shading to distinguish between over reduction regions in which the preparation object file is recessed relative to the target object file and under reduction regions in which the preparation object file protrudes relative to the target object file.

25. The method according to claim 21 wherein the assessment system is configured to calculate the similarity measure at least in part using an artificial intelligence based similarity algorithm which is configured to measure similarity between the preparation object file and the at least one target object file using a database of training target object files.

26. An assessment system for assessing a dental preparation of at least one tooth of a dental training model, the system comprising:
a processor and a memory storing programming instructions thereon arranged to be executed by the processor so as to be configured to:
acquire a preparation object file defining three-dimensional surfaces of said at least one tooth;
determine an identity of said at least one tooth of the dental training model within the preparation object file; and
calculate a grading report of the dental preparation of the at least one tooth by comparison to a reference object file defining three-dimensional surfaces of at least one reference tooth stored on the assessment system in association with the identity of said at least one tooth.
